(19) United States
(12) Patent Application Publication
(10) Pub. No.: US 2002/0021875 A1
(43) Pub. Date: Feb. 21, 2002

(54) Ferrule fixed module

(75) Inventors: Kiyokazu Tateno, Tokyo (JP); Shinichiro Iizuka, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., CHIYODA-KU (JP)

(21) Appl. No.: 09/911,470

(22) Filed: Jul. 25, 2001

(30) Foreign Application Priority Data
Jul. 25, 2000 (JP) 2000-223983
Jul. 13, 2001 (JP) 2001-213600

(51) Int. Cl. G02B 6/42; G02B 6/36

(52) U.S. Cl. 385/91; 385/88; 385/78

(57) ABSTRACT

A ferrule fixed module of the invention has the high aligning fixing accuracy of a ferrule to a coupling counter part and is low costs. Additionally, the ferrule fixed module of the invention can shorten the fabrication time thereof. The coupling end surface side of a lensed fiber (8) inserted and fixed to a first ferrule (4a) is faced to a laser diode chip (3) in the aligned state and the ferrule (4a) is fixed to a base (1) through a ferrule fixing component (10). The ferrule fixing component (10) is formed of clamping parts (6) having paired arm parts (12) for clamping and fixing the ferrule (4a) at the parts near the laser diode chip (3) from both sides of side parts and clamping parts (7) having paired arm parts (13) for clamping and fixing the ferrule (4a) at the parts far from the laser diode chip (3) from both sides of the side parts. The tip end spacings of the arm parts (12) and (13) are formed wider than the width of the ferrule (4a) and the ferrule (4a) is fixed to the ferrule fixing component (10) by the first clamping parts (6) and the second clamping parts (7).

### BACKGROUND OF THE INVENTION

A laser diode module is that a laser diode (LD) chip for outputting laser light is optically coupled to an optical fiber for propagating light from the laser diode chip beforehand to form a module. FIGS. 9A and 9B show one of configurational examples of the laser diode module.

The laser diode module shown in FIGS. 9A and 9B has a metal package 19. FIG. 9A depicts a plane configuration of the laser diode module, omitting the top wall of the package 19. Additionally, FIG. 9B depicts a side configuration of the laser diode module, partially omitting the side wall of the package 19. A laser diode chip 3 is fixed to a chip mounting platform 2 of a base 1 that is fixed in the package 19 through a carrier 22.

Furthermore, the tip end side of a lensed fiber 8 is inserted into the package 19 from an insertion part 25 disposed in the side wall of the package 19. The lensed fiber 8 is an optical fiber formed with a lens 5 on the tip end side. The lens 5 of the lensed fiber 8 is faced to the light emitting part of the laser diode chip 3 in the aligned state. That is, the laser diode chip 3 and the lensed fiber 8 are arranged to face each other so that the excitation efficiency (optical coupling efficiency) of the laser diode chip 3 and the lensed fiber 8 becomes maximum.

A first ferrule 4a is fixed to the base 1 through a forward supporting component 23 and a back supporting component 24. The tip end side of the lensed fiber 8 is inserted and fixed to the first ferrule 4a. The lens 5 that is formed on the tip end side of the lensed fiber 8 is fixed as it is protruded from the tip end of the first ferrule 4a toward the laser diode chip 3. The tip end of the lens 5 is faced to the laser diode chip 3. In addition, 21 denotes a thermister in FIG. 9A.

The first ferrule 4a is clamped and fixed by the forward supporting component 23 from both sides at the parts near the laser diode chip 3. Furthermore, the first ferrule 4a is clamped and fixed by the back supporting component 24 from both sides at the parts far from the laser diode chip 3, the back supporting component 24 are disposed separately from the forward supporting component 23. Moreover, each of 9a, 9b, 9f and 9g denotes YAG welding fixing parts in FIGS. 9A and 9B.

A second ferrule 4b is disposed on the back end side of the first ferrule 4a with spacing. A midway part of the lensed fiber 8 is inserted and fixed to the second ferrule 4b. As shown in FIGS. 9A and 9B, the second ferrule 4b is inserted in the insertion part 25 of the package 19 and is secured to the side wall of the package 19 through a ferrule fitting part 16 that is disposed in the package 19.

Besides, a monitor photodiode 11 carrier-mounted is fixed to the base 1 and a Peltier module 20 is disposed on the under side of the base 1. The Peltier module 20 is configured to have a Peltier device for maintaining temperatures of the laser diode chip 3.

In addition, the lensed fiber 8 between the first ferrule 4a and the second ferrule 4b is applied with metal plating on the surface side thereof. One end side of this metal plating part is fixed to the second ferrule 4b by soldering. The second ferrule 4b is fixed to the ferrule fitting part 16 by soldering. The metal plating part of the lensed fiber 8 is solder-fixed to the second ferrule 4b and the second ferrule 4b is solder-fixed to the ferrule fitting part 16. Thereby, the inside of the package 19 is formed to be hermetic.

### SUMMARY OF THE INVENTION

A ferrule fixed module of the invention comprises:

an optical component,

a ferrule inserted and fixed with an optical fiber; and

a ferrule fixing component for fixing the ferrule to a base,

wherein the ferrule fixing component is configured of one member having clamping parts for the ferrule,

the clamping parts are formed of paired arm parts extending toward the ferrule in an arm shape, and

a joining end surface side of the optical fiber is faced to said optical component in an aligned state.

### BRIEF DESCRIPTION OF THE DRAWINGS

Exemplary embodiments of the invention will now be described in conjunction with drawings, in which:

FIGS. 1A, 1B and 1C depict main configurational diagrams illustrating a structure of fixing the ferrule to the base in one embodiment of the ferrule fixed module in the invention;

FIG. 2 depicts an illustration showing a method for fabricating the ferrule fixed module of the embodiment described above;

FIG. 3A depicts an illustration showing physical relationship of the ferrule, between the ferrule and first clamping parts before the first clamping parts are fixed in the ferrule fixed module of the embodiment mentioned above.

FIG. 3B depicts an illustration showing physical relationship between the ferrule and the first clamping parts after the ferrule has been fixed, and a state of arm parts being deformed in the ferrule fixed module of the embodiment mentioned above

FIGS. 4A, 4B, 4C, 4D, 4E, 4F and 4G depict front illustrations showing examples of the structure of fixing the ferrule to the base in other embodiments of the ferrule fixed module in the invention;

FIGS. 4H, 4I, 4J and 4K depict side illustrations showing examples of the structure of fixing the ferrule to the base in other embodiments of the ferrule fixed module in the invention;

FIGS. 5A, 5B and 5C depict front illustrations showing other examples of the structure of fixing the ferrule to the base in other embodiments of the ferrule fixed module in the invention;

FIGS. 5D, 5E and 5F depict side illustrations showing other examples of the structure of fixing the ferrule to the base in other embodiments of the ferrule fixed module in the invention;

FIGS. 6A, 6B and 6C depict main configurational diagrams illustrating the structure of fixing the ferrule to the base in still other embodiments of the ferrule fixed module in the invention;

FIGS. 7A, 7B and 7C depict main configurational diagrams illustrating the structure of fixing the ferrule to the base in yet other embodiments of the ferrule fixed module in the invention;

FIGS. 8A, 8B and 8C depict main configurational diagrams illustrating the structure of fixing the ferrule to the base in still yet other embodiments of the ferrule fixed module in the invention; and

FIGS. 9A and 9B depict illustrations showing a configuration of the laser diode module as an orthodox ferrule fixed module.

### DETAILED DESCRIPTION

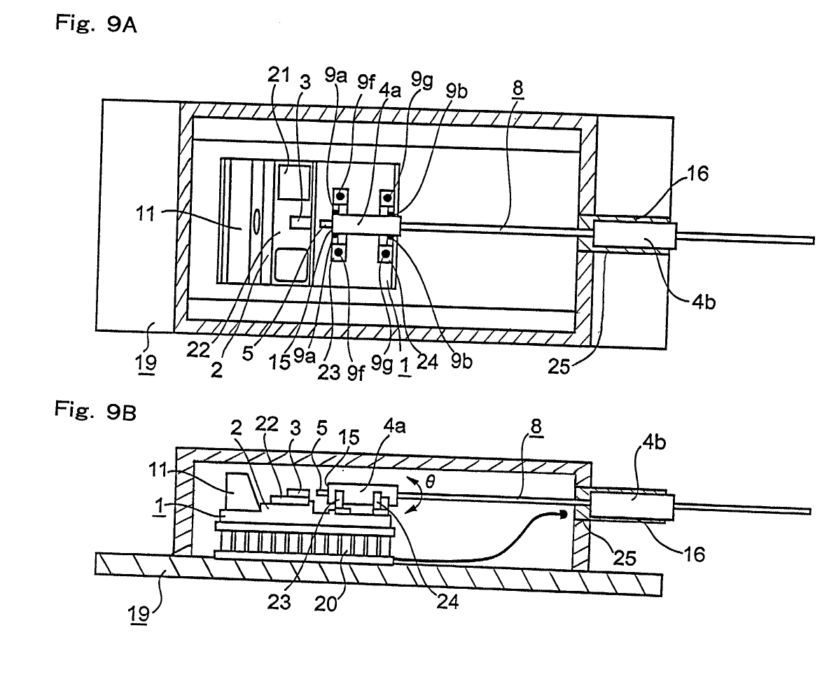

The main points of a method for fixing the first ferrule 4a to the base 1 in a method for fabricating the laser diode module of the configuration shown in FIGS. 9A and 9B are described as follows. That is, the laser diode chip 3 is arranged and fixed to the chip mounting platform 2 and the first ferrule 4a is disposed on the forward supporting component 23, for example. Then, the laser diode chip 3 and the lensed fiber 8 are arranged in the aligned state in the X-, Y- and Z-axial directions. Subsequently, in this aligned state, the forward supporting component 23 is fixed to the base 1 at the YAG welding fixing parts 9f and the first ferrule 4a is fixed to the forward supporting component 23 at the YAG welding fixing parts 9a.

Then, with the YAG welding fixing parts 9a as supporting points, the first ferrule 4a is tilted and moved in the θ direction shown in FIG. 9B, and the tip end side of the lens 5 of the lensed fiber 8 is slightly moved in the Y-axial direction. Then, this slight movement allows the optical axis of the laser diode chip 3 and the lensed fiber 8 to be aligned in the Y-axial direction. Subsequently, the back supporting component 24 is fixed to the base 1 at the YAG welding fixing parts 9g in this state, and the first ferrule 4a is fixed to the back supporting component 24 at the YAG welding fixing parts 9b.

In the application of the fixing method described above, the first ferrule 4a can be fixed at two positions on the sides near and far from the laser diode chip 3 and thus a tip end 15 of the first ferrule 4a can be prevented from moving. On this account, the application of the fixing method described above can maintain the lensed fiber 8 faced to the light emitting part of the laser diode chip 3 in the aligned state.

When the laser diode module is configured by using the lensed fiber 8 as described above, the parts configuration becomes simple and therefore there is advantage of saving costs. In addition, the shape of the lens 5 of the lensed fiber 8 is optimized. Thereby, the optical coupling efficiency of the lensed fiber 8 to the laser diode chip 3 can be highly enhanced and an excellent laser diode module can be formed.

However, the orthodox laser diode module shown in FIGS. 9A and 9B uses two components (members), the forward supporting component 23 and the back supporting component 24, to fix the first ferrule 4a to the base 1. Thus, it has had problems described as follows.

First, the orthodox laser diode module shown in FIGS. 9A and 9B has had a problem that a parts count becomes high, which causes a cost increase in the laser diode module.

Secondly, in the orthodox laser diode module shown in FIGS. 9A and 9B, the position of the forward supporting component 23 or the back supporting component 24 tends to shift due to the package deformation or the like and the lensed fiber 8 has happened to shift from the aligning position.

Thirdly, the orthodox laser diode module shown in FIGS. 9A and 9B has to separately fix the forward supporting component 23 to the base 1, the back supporting component 24 to the base 1, the first ferrule 4a to the forward supporting component 23 and the first ferrule 4a to the back supporting component 24. Accordingly, the orthodox laser diode module described above is complex in fabrication. Accompanying that, there has been a problem that the fabrication time and costs of the laser diode module are increased and the laser diode module is not suit for mass production.

One aspect of the ferrule fixed module in the invention is a ferrule fixed module having the high aligning fixing accuracy of an optical fiber to a coupling counter part optical component such as a laser diode and having decreased fabrication time and costs.

Previously, as described above, the ferrule fixed module such as the laser diode module has been configured in which the member to fix the ferrule at the parts near the coupling counter part optical component and the member to fix the ferrule at the parts far from the coupling counter part optical component are disposed separately. The reason to apply this configuration is as follows. That is, the ferrule fixed module is generally formed in which the ferrule is fixed at the parts near the coupling counter part optical component in the state where the optical fiber secured to the ferrule is aligned with the coupling counter part optical component, the ferrule is then slightly moved by using the fixing parts as the supporting points and the optical fiber secured to the ferrule is again aligned and fixed. In this case, it has been considered that separately disposing the members to fix the ferrule at the parts near and far from the coupling counter part optical component to align and fix it has excellent workability and improves the aligning fixing accuracy as well.

However, when the inventor conducted studies with the shapes of the ferrule fixing component changed variously, it was found that the optimum configuration of the ferrule fixing component is the following configuration. That is, the ferrule fixing component is formed of one member having clamping parts made of paired arm parts that are formed in an arm shape extending to the ferrule. In the case of forming in this manner, for example, at the time when the ferrule is fixed to the ferrule fixing component by an appropriate fixing method such as laser welding or bonding at joining parts or joining points in the tip ends of the clamping parts, the constriction in the fixing part at this fixing time deforms and draws the arm parts to the ferrule side and thus the deformation occurs smoothly. On this account, the ferrule fixing component is formed of one member having the clamping parts made of the paired arm parts and thereby the improvement of the aligning fixing accuracy can be intended.

The invention has been configured according to the studies described above. Thus, the optical fiber is easily aligned and fixed to the coupling counter part optical component and the aligning fixing accuracy can be enhanced. Additionally, the invention can also decrease the costs of the module by the reduced parts count constituting the module. Furthermore, the configuration where the ferrule fixing component is formed of one member includes the configuration where the clamping parts are disposed on the base to integrate the ferrule fixing component into the base.

Hereafter, the embodiments of the invention will be described in accordance with the drawings. In addition, in the following description, components having the same designation as the orthodox example are designated the same reference numerals and signs, omitting the overlapping description.

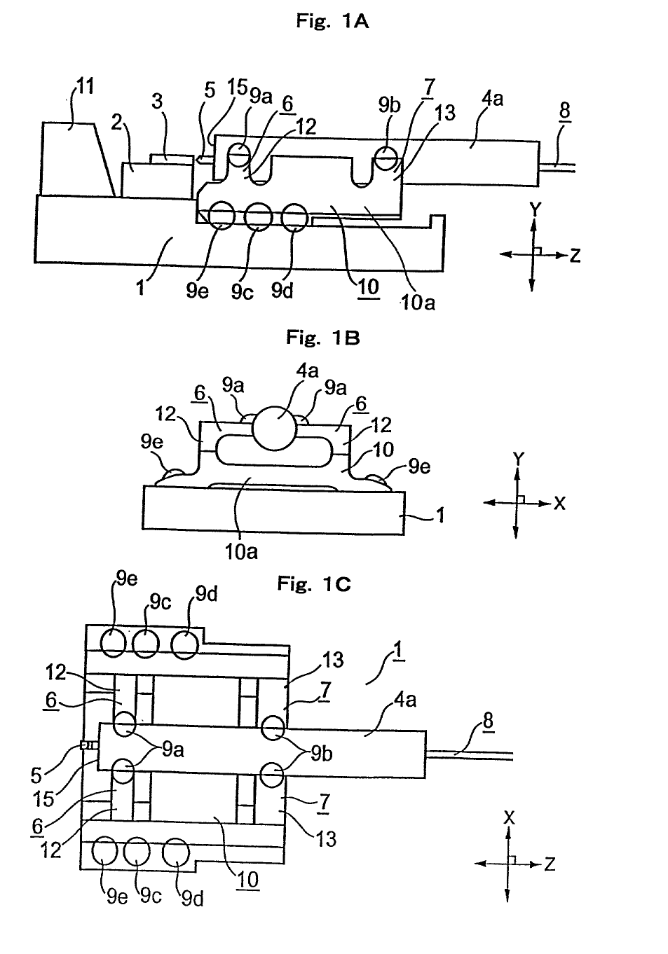

FIGS. 1A, 1B and 1C depict the structure of fixing a first ferrule 4a to a base in one embodiment of the ferrule fixed module in the invention. FIG. 1A depicts a side view of the fixing structure. FIG. 1B depicts a front view of the fixing structure. FIG. 1C depicts a plane view of the fixing structure. The ferrule fixed module in the embodiment is a laser diode module.

The fixing structure of the embodiment is characterized in that the fixing structure of the first ferrule 4a to the base is formed in a distinctive structure shown in FIGS. 1A, 1B and 1C.

As shown in FIGS. 1A, 1B and 1C, the ferrule fixed module of the embodiment has the first ferrule 4a inserted and fixed with a lensed fiber 8 and a ferrule fixing component 10 for fixing the first ferrule 4a to the base 1. The ferrule fixing component 10 is configured of one member having clamping parts 6 and 7 for the first ferrule 4a. The clamping parts 6 and 7 are formed of paired arm parts 12 and 13 extending to the first ferrule 4a in an arm shape, respectively. The clamping parts 6 and 7 are formed along the longitudinal direction of the first ferrule 4a. The clamping parts 6 are formed at the parts near a laser diode chip 3, which is the coupling counter part optical component, and the clamping parts 7 are formed at the parts far from the laser diode chip 3.

The arm parts 12 and 13 are raised from a base part 10a of the ferrule fixing component 10, bent in an L-shape, and extended to the ferrule 4a. Each of the tip ends (arm part tip end) of the arm parts 12 and 13 is laser-welded with the ferrule 4a to form the joining points of welding parts (YAG welding fixing parts) 9a and 9b. In addition, an arm part tip end spacing W2 between the first clamping parts 6 and an arm part tip end spacing W3 between the second clamping parts 7 may be the same or different but the realigning operation, which will be described later, is easily conducted when it is set W2≦W3.

The embodiment is configured as described above. Next, a method for fabricating the laser diode module of the embodiment will be described. First, as shown in FIGS. 1A, 1B and 1C, the lensed fiber 8 is fixed inside the first ferrule 4a by soldering. Then, the laser diode chip 3 is fixed on a chip mounting platform 2. Subsequently, a monitor photodiode 11 and the chip mounting platform 2 with the laser diode chip 3 are properly mounted and fixed to the base 1. Then, on a Peltier module 20 inside a package 19, the base 1 mounted with each of the components is mounted and fixed.

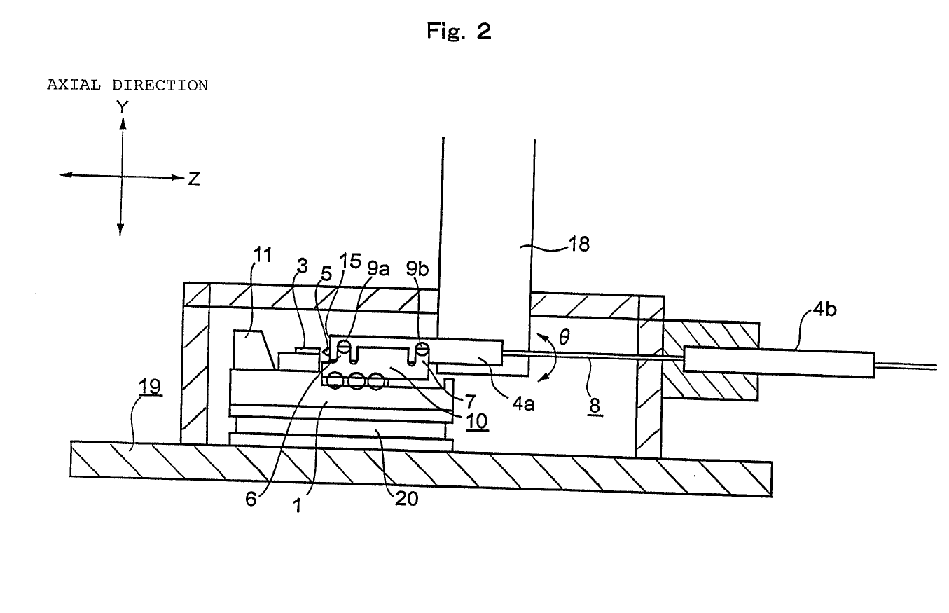

After that, as shown in FIG. 2, a hand (ferrule gripper) 18 grips the first ferrule 4a to place it between the first clamping parts 6 and the second clamping parts 7 of the ferrule fixing component 10. In this state, the ferrule fixing component 10 is mounted on the base 1 and the first ferrule 4a is three-dimensionally moved and aligned so that the quantity of light becomes maximum. At this time, the alignment position is adjusted so as to evenly arrange the first ferrule 4a between the clamping parts 6.

The alignment mentioned above is conducted by receiving the laser light emitted from the laser diode chip 3 by the lensed fiber 8 and detecting the received light by an optical receiver connected on the back end part of the lensed fiber 8. Then, the first ferrule 4a is moved in the X-, Y- and Z-directions so that the detected light becomes maximum and thereby the excitation efficiency (optical coupling efficiency) of the laser diode chip 3 with the lensed fiber 8 is to be the maximum. In addition, such an aligning method is called a power aligning here.

After the alignment mentioned above, the ferrule fixing component 10 is fixed to the base 1 by laser welding at YAG welding fixing parts 9c, 9d and 9e in the aligned state. The ferrule fixing component 10 is a one-piece unit equipped with the first clamping part 6 and the second clamping part 7 and thus it facilitates fixing.

Then, the first ferrule 4a is three-dimensionally moved and aligned so that the quantity of light becomes maximum, and the first clamping parts 6 are fixed to the first ferrule 4a at the YAG welding fixing parts 9a by laser welding. Additionally, the first ferrule 4a has been evenly arranged between the arm parts 12 and 13 beforehand. Thus, when the first ferrule 4a is YAG-welded and fixed to each of the arm parts 12 and 13, contractive forces of the right and left YAG welding fixing parts 9a balance each other out to prevent the first ferrule 4a from being shifted in the X-direction.

Subsequently, the first ferrule 4a is axially moved with the first clamping parts 6 as the supporting points. Thereby, it is realigned so that the quantity of light becomes maximum and then the first ferrule 4a is laser-welded and fixed with the second clamping parts 7 at the YAG welding fixing parts 9b.

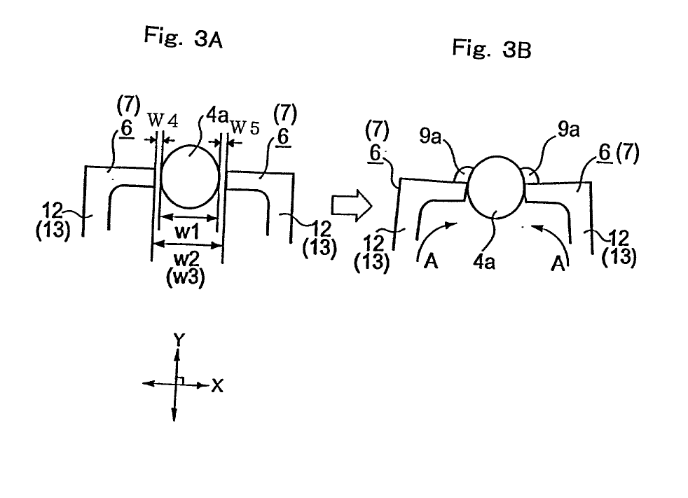

Here, on the laser diode module of the embodiment as shown in FIG. 3A, the arm part tip end spacings W2 and W3 of the first and second clamping parts 6 and 7 are formed a proper value (about 0.5 to about 200 μm, for example) wider than a width W1 of the first ferrule 4a (the values of W4 and W5 are set about 0.5 to about 200 μm).

And the first ferrule 4a is clamped by the first and second clamping parts 6 and 7 for YAG-welding and fixing. Then, the arm parts 12 and 13 constituting the first and second clamping parts 6 and 7 are deformed and drawn to the first ferrule 4a side, and the first ferrule 4a is fixed at the aligning position. In this manner, the values of W1, W2 and W3 are optimized and thereby the first ferrule 4a can be aligned and fixed at the aligning position with high accuracy.

Additionally, in case where the arm part tip ends of the first and second clamping parts 6 and 7 and the first ferrule 4a are not spaced, the first ferrule 4a will be shifted 2 μm or greater from the planned fixing position in the X-direction, for example, when fixing the first ferrule 4a. When this happens, the light receiving power of the optical fiber (here, the lensed fiber 8) becomes smaller and laser light might not enter the optical fiber at all. On the other hand, when the spacings W4 and W5 are set wider than 200 μm, the first ferrule 4a might be shifted 2 μm or greater from the planned fixing position in the X-direction, for example, or YAG welding fixing might become difficult. Thus, it is important to properly form the spacings described above.

Furthermore, in the embodiment, the paired arm parts 12 and 13 constituting the first and second clamping parts 6 and 7 are raised from the base part 10a of the ferrule fixing component 10, bent in an L-shape and extended toward the ferrule 4a. Therefore, the embodiment easily conducts the deformation and movement of the arm parts when YAG welding fixing and further enhances the aligning fixing accuracy described above.

Moreover, in the embodiment, the ferrule fixing component 10 having the first and second clamping parts 6 and 7 is formed of one member and thus the module fabrication is also facilitated. Accordingly, the embodiment can reduce the fabrication costs of the ferrule fixed module and can further decrease the costs of the module by the lower parts count in constituting the module.

Besides, in the embodiment, the clamping parts 6 and 7 are disposed along the longitudinal direction of the first ferrule 4a with spacing. When a plurality of clamping parts 6 and 7 are thus disposed along the longitudinal direction of the first ferrule 4a, the tip end 15 of the first ferrule 4a can be prevented from moving. Accordingly, in the embodiment, the lensed fiber 8 and the light emitting part of the laser diode chip 3 can be maintained in the faced conditions in the aligned state.

In addition, the embodiment is a laser diode module having the laser diode chip 3 and the lensed fiber 8, in which the tip end of the lensed fiber 8 is protruded from the tip end of the first ferrule 4a toward the laser diode chip 3 side and the laser diode chip 3 and the lensed fiber 8 are faced each other in the aligned state.

Accordingly, the embodiment can realize the laser diode module having the high aligning fixing accuracy of the laser diode chip 3 with the lensed fiber 8 and the reduced parts costs or the deceased fabrication time and costs.

In addition, the invention is not limited to the embodiment described above, which can adopt various embodiments. For example, in the embodiment, the ferrule fixing component 10 was configured to have the first and second clamping parts 6 and 7 having the shape shown in FIGS. 1A, 1B and 1C. However, the shape of the clamping parts 6 and 7 is not defined in particular, which can be set arbitrarily.

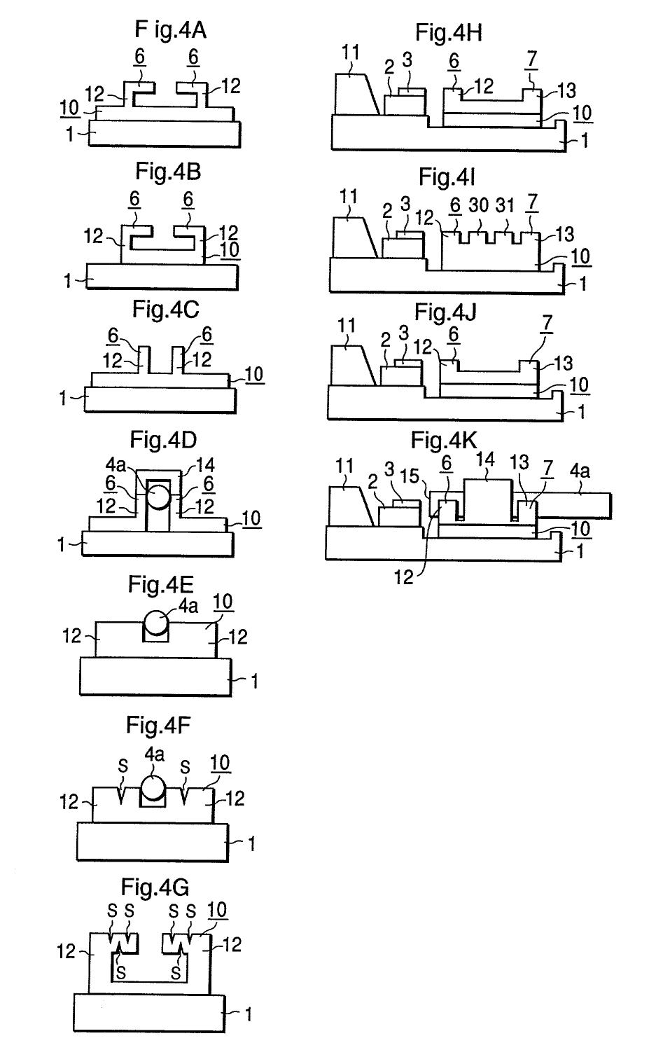

For example, each of FIGS. 4A to 4K depict other configurational examples of the ferrule fixing component 10 along with the base 1. FIG. 4A is a front view of a first configurational example, and FIG. 4H is a side view of the first configurational example. FIG. 4B is a front view of a second configurational example, and FIG. 4I is a side view of the second configurational example. FIG. 4C is a front view of a third configurational example, and FIG. 4J is a side view of the third configurational example. FIG. 4D is a front view of a fourth configurational example, and FIG. 4K is a side view of the forth configurational example. FIG. 4E is a front view of a fifth configurational example, FIG. 4F is a front view of a sixth configurational example and FIG. 4G is a front view of a seventh configurational example.

As shown in these drawings, the ferrule fixed module 10 adapted to the invention may be one member having one or more of clamping parts made of paired arm parts that extend to a ferrule (here, the first ferrule 4a) in an arm shape on both sides. The clamping parts 6 and 7 are formed with the paired arm parts 12 and 13 in various shapes, as shown in each of FIGS. 4A to 4K.

Additionally, at least one of the clamping parts 6 and 7 is preferably configured to have paired arm parts. In the configuration shown in the embodiment or in FIGS. 4A and 4B, each of the paired arm parts 12 and 13 constituting the clamping parts 6 and 7 is raised upward from the peripheral positions on both sides of the first ferrule 4a to form approximately L-shaped arm parts extended to the side part of the first ferrule 4a. This configuration allows the arm parts to be deformed and moved easily when YAG welding fixing and can further enhance the aligning fixing accuracy mentioned above. In addition, as shown in FIG. 4C, the paired arm parts 12 and 13 may have the shape that is simply raised upward from the base part of the ferrule fixing component.

Furthermore, as shown in FIG. 4I, the second configuration is that the ferrule fixing component 10 is provided with third and fourth clamping parts 30 and 31 other than the first and second clamping parts 6 and 7 to form the ferrule fixing component 10 having a plurality of clamping parts more than two. Moreover, as shown in FIG. 4D, the fourth configuration is that the ferrule fixing component 10 is provided with a cylindrical part 14 and the first ferrule 4a is inserted and fixed to the cylindrical part 14.

Besides, the configurations shown in FIGS. 4E, 4F and 4G form the arm parts into a thick block shape. In such configurations of the arm parts, as shown in FIGS. 4F and 4G, slits S for facilitating the deformation and movement of the arm parts 12 may be disposed.

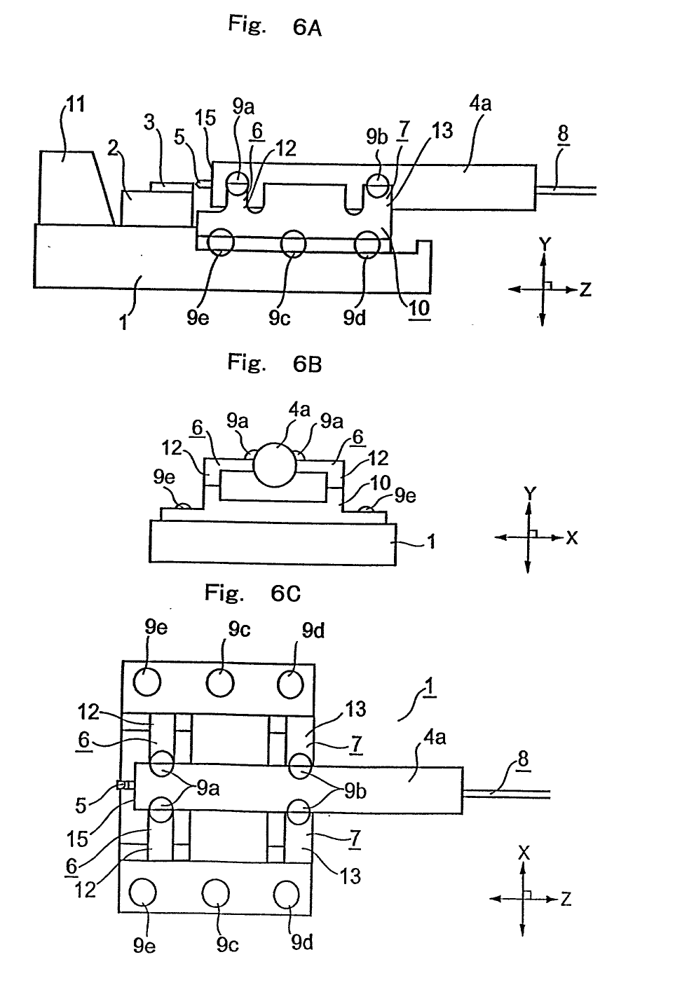

In addition, in the embodiment, the ferrule fixing component 10 was fixed to the base 1 at the YAG welding fixing parts 9c to 9e disposed on the forward side thereof (the parts near the laser diode chip 3) by laser welding. However, the ferrule fixing component 10 may be fixed to the base 1 at the YAG welding fixing parts 9c to 9e as shown in the side view of FIG. 6A, the front view of FIG. 6B and the plane view of FIG. 6C. In this manner, when the YAG welding fixing parts 9c to 9e are evenly arranged in the longitudinal direction of the ferrule fixing component 10 with spacing, the fine adjustment in fixing the ferrule fixing component 10 to the base 1 can be facilitated.

Furthermore, in each of the embodiments described above, a plurality of clamping parts having the arm parts for forming the joining points was disposed in the longitudinal direction of the ferrule to stably support and fix the ferrule 4a but the clamping parts may be the singular number.

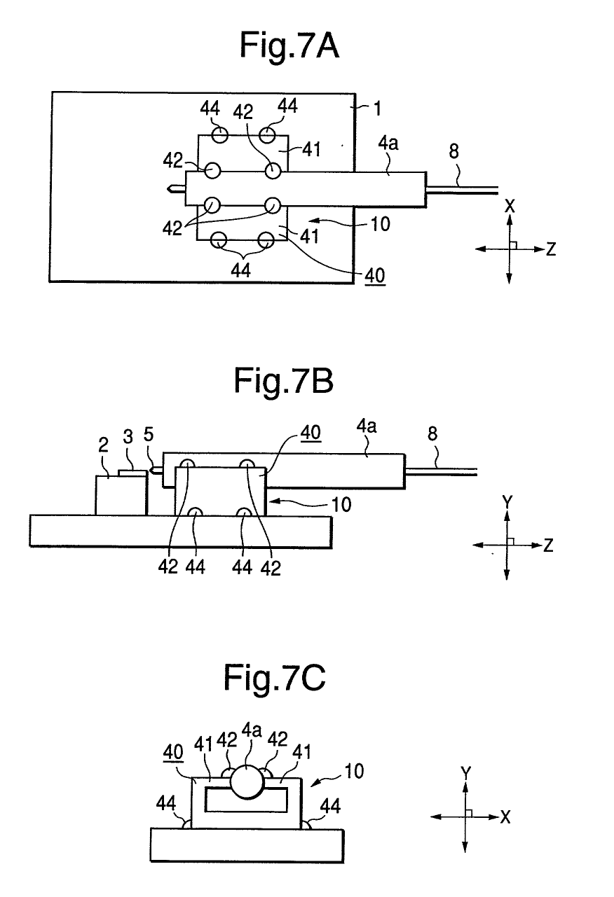

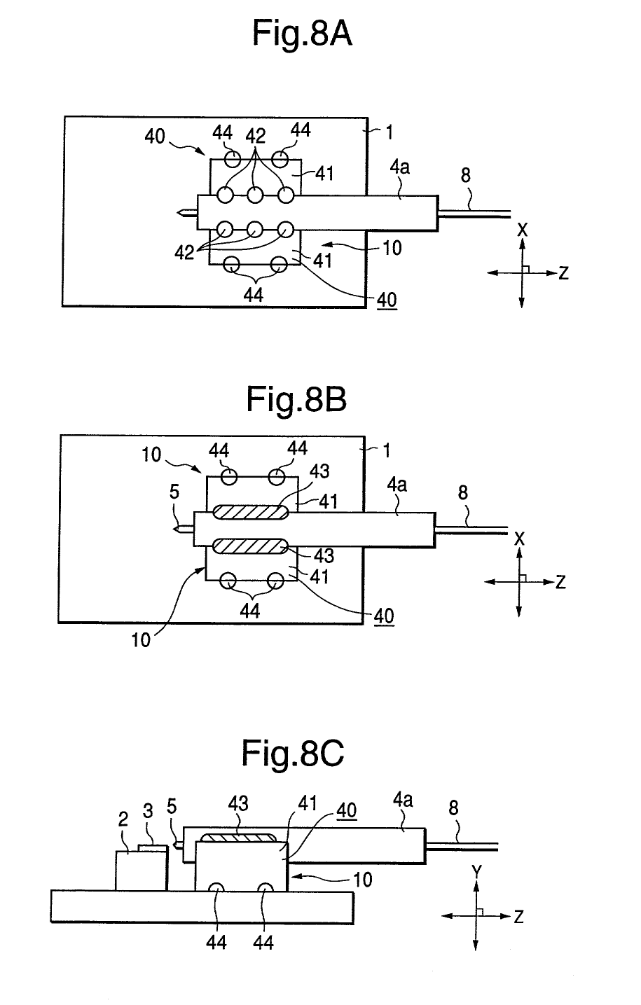

For example, a clamping part 40 shown in the front view of FIG. 7A and the side view of FIG. 7B is formed of paired arm parts 41, similar to the case of each of the embodiments, as shown in the front view of FIG. 7C. However, as shown in FIGS. 7A and 7B, the clamping part 40 is formed in an oblong shape extending in the longitudinal direction of the ferrule 4a. The joining end parts of the arm parts are fixed to the ferrule 4a at two joining points 42 by laser welding on both sides of the ferrule 4a in the longitudinal direction of the ferrule 4a. Besides, as shown in the plane view of FIG. 8A, the joining points 42 may be formed three or more.

Additionally, as shown in the plane view of FIG. 8B and the side view of FIG. 8C, the fixing parts are not to be the joining parts; they can be joining lines 43 extending in the longitudinal direction of the ferrule 4a. That is, in the example of FIGS. 8B and 8C, the ferrule 4a is laser-welded to the fixing component 10 in a line shape extending in the longitudinal direction.

It is of course possible to arrange these joining points and joining lines combined arbitrarily in the longitudinal direction of the ferrule 4a. In this manner, the clamping parts are formed long in the longitudinal direction of the ferrule 4a and thereby the shape (points or lines) or number of the fixing parts and positions in the longitudinal direction of the ferrule 4a can be set arbitrarily and the design change of the fixing parts are facilitated.

Furthermore, in each of FIGS. 7A, 7B, 7C, 8A, 8B and 8C, the reference numeral 44 denotes the fixing parts of the ferrule fixing component 10 to the base 1 by laser welding.

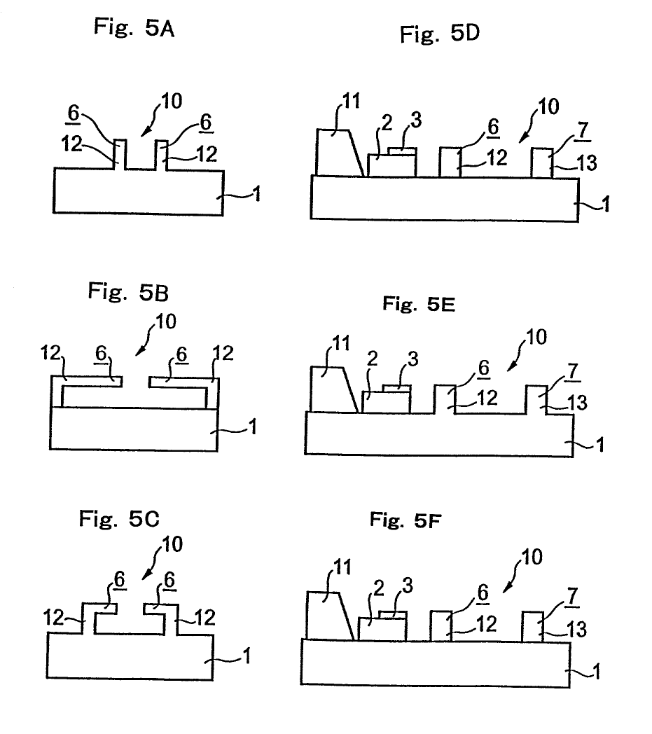

Moreover, in each of the embodiments, the first ferrule 4a was fixed to the base 1 through the ferrule fixing component 10. However, as shown in each of FIGS. 5A to 5F, the ferrule fixing component 10 can be integrated into the base 1. FIG. 5A is a front view of a first configurational example of the integrated configuration where the ferrule fixing component 10 is integrated into the base 1. FIG. 5D is a side view of the first configurational example of the integrated configuration. FIG. 5B is a front view of a second configurational example of the integrated configuration. FIG. 5E is a side view of the second configurational example of the integrated configuration. FIG. 5C is a front view of a third configurational example of the integrated configuration. FIG. 5F is a side view of the third configurational example of the integrated configuration.

When the integrated configuration where the ferrule fixing component 10 is integrated into the base 1 is applied, it is conduced as follows. That is, first, the joining end surface side of the optical fiber inserted and fixed to the ferrule is faced to the joining counter part optical component fixed to the base in the aligned state. Then, the clamping parts 6 having the paired arm parts 12 for clamping and fixing the ferrule at the parts near the joining counter part optical component (in the same drawing, the laser diode chip 3) from both sides are disposed on the base 1. Also, the clamping parts 7 having the paired arm parts 13 for clamping and fixing the ferrule at the parts far from the joining counter part optical component from both sides are disposed on the base 1. Then, the ferrule is YAG-welded and fixed to the base 1 at least in the clamping parts 6 and 7 and thereby almost the same effects as the embodiment described above can be exerted.

Additionally, when applying the integrated configuration, the shape of the arm parts constituting the clamping parts 6 and 7 is not defined particularly, which can be set arbitrarily. For example, the arm parts 12 and 13 having various shapes as shown in FIGS. 5A to 5C are adapted.

Furthermore, in the embodiment described above, the ferrule 4a was fixed to the ferrule fixing component 10 by laser welding such as YAG welding. However, fixing the ferrule 4a to the ferrule fixing component 10 is not limited to laser welding. It may be conducted by soldering or the like.

Moreover, the ferrule fixed module of the invention is not limited to the laser diode module as described above, which can be set arbitrarily. The ferrule fixed module of the invention can be applied to various ferrule fixed modules formed by facing the joining end surface side of the optical fiber inserted and fixed to the ferrule to the joining counter part optical component fixed to the base in the aligned state and fixing the ferrule directly to the base or through the ferrule fixing component.

What is claimed is:

1. A ferrule fixed module comprising:
an optical component,
a ferrule inserted and fixed with an optical fiber; and
a ferrule fixing component for fixing the ferrule to a base,
wherein said ferrule fixing component is configured of one member having clamping parts for the ferrule,
the clamping parts are formed of paired arm parts extending toward the ferrule in an arm shape, and
a joining end surface side of said optical fiber is faced to said optical component in an aligned state.

2. The ferrule fixed module according to claim 1, wherein a tip ends of the arm parts are formed with at least one of a joining point or joining line.

3. The ferrule fixed module according to claim 1, wherein a plurality of clamping parts is formed along a longitudinal direction of the ferrule.

4. The ferrule fixed module according to claim 1, wherein the arm parts are formed in an oblong shape extending in a longitudinal direction of the ferrule.

5. The ferrule fixed module according to claim 1, wherein a width between tip ends of the arm parts that are faced each other is formed 0.5 to 200 μm wider than a width of the ferrule.

6. The ferrule fixed module according to claim 1, wherein the ferrule is evenly arranged between tip ends of the arm parts that are faced each other.

7. The ferrule fixed module according to claim 1, wherein the arm parts are raised from a base part of the ferrule fixing component and extended toward the ferrule in an L-shape.

8. The ferrule fixed module according to claim 1 having a following configuration, the ferrule fixed module comprising:
a laser diode chip to be said optical component; and
a lensed fiber formed with a lens on a tip end side of the optical fiber,
wherein a tip end side of the lensed optical fiber is fixed as it is protruded from a tip end of the ferrule toward said laser diode chip, and
the tip end side of the lensed optical fiber is faced to a light emitting part of said laser diode chip in an aligned state.
